(19) United States
(12) Patent Application Publication
(10) Pub. No.: US 2006/0148565 A1
(43) Pub. Date: Jul. 6, 2006

(54) Tournament for gaming machines

(76) Inventors: Michael Gauselmann, Espelkamp (DE); Heribert Moik, Graz (AT)

Correspondence Address: PATENT LAW GROUP LLP, 2635 NORTH FIRST STREET, SUITE 223, SAN JOSE, CA, 95134, US

(21) Appl. No.: 11/029,799

(22) Filed: Jan. 4, 2005

(51) Int. Cl. G06F 19/00

(52) U.S. Cl. 463/41

(57) ABSTRACT

A tournament server intermittently initiates a tournament for any number of gaming machines connected to a network. An operator sets the parameters of the tournament, such as the scheduling, the criteria for winning, and the awards. The tournament server controls a display, such as an overhead display or a display on each gaming machine. The tournament server receives pay-in/pay-out data or any other relevant data from the gaming machines and determines the rankings of the players. At the end of the tournament, the winning player is awarded a prize. The tournament server and tournament technique can be implemented without reconfiguring the gaming machines, and a variety of types of gaming machines by different manufacturers may participate in the same tournament.

### FIELD OF THE INVENTION

This invention relates to gaming machines (also called slot machines) and, in particular, to a tournament played on a plurality of gaming machines linked to a server.

### BACKGROUND

It is common for gaming machines in a casino to be connected in a communications network so that accounting information is readily available to the casino. Such accounting information includes the bets, pay-in, payout, and other information for each machine.

Players typically play the gaming machines for long periods of time, and such play becomes monotonous. Since the playing experience does not change over time, players are not encouraged to continue playing the machines.

What is needed is a way to maintain the excitement of the playing experience.

### SUMMARY

A technique is described herein for intermittently initiating a tournament for any number of gaming machines in communication with a tournament server. An operator sets the parameters of the tournament, such as the scheduling, the criteria for winning, the gaming machines participating, and the awards. The tournament server controls a display, such as an overhead display or a display on each gaming machine.

When a tournament is initiated, the players of the selected machine are notified of the tournament by, for example, a video display and sounds. The tournament server then receives pay-in/pay-out data or any other relevant data (e.g., maxbet wagers) from the gaming machines and determines the rankings of the players. The current rankings may be displayed on an overhead display. At the end of the tournament, the winning player is awarded a prize.

During the tournament, the players wager their own credits and keep the winnings from the games. The tournament prizes may be fully funded by the casino rather than by a percentage of the wagers made. Suitable prizes may be free meals, discounts, comps, chips, credits, money, etc. The longer play of the machines due to the players wanting to participate in the intermittent tournaments generates added revenue that more than offsets the tournament prize value.

Since the tournament server uses data from the gaming machines that is normally transmitted to the casino's accounting server and the odds of payouts are not changed to fund any tournament pool, the gaming machines do not need to be reconfigured for participating in the tournament. Therefore, the tournament server and tournament technique can be implemented easily, and a variety of types of gaming machines by different manufacturers may participate in the same tournament.

### BRIEF DESCRIPTION OF THE DRAWINGS

FIG. 1 is a functional diagram of the tournament server connected to the communication board in a plurality of gaming machines.

FIG. 2 illustrates a gaming machine in more detail.

FIG. 3 is a high level flowchart of one embodiment of the tournament routine.

FIG. 4 is a more detailed flowchart of one embodiment of the tournament routine.

### DETAILED DESCRIPTION

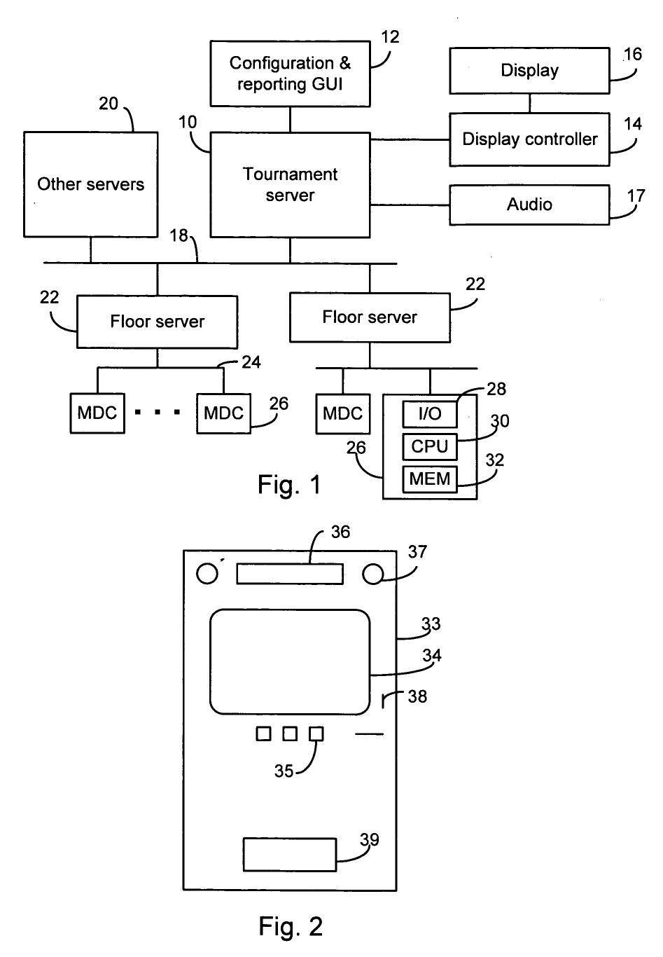

FIG. 1 illustrates one embodiment of a system used to carry out a tournament. A tournament server 10 carries out most of the functions for a tournament. The tournament server 10 may be any suitable computer programmed to carry out the functions described below. The tournament server 10 may consist of a single computer unit or multiple units. The tournament server 10 may run a java application that provides authentication of player identification (if player identification cards are used), configuration of the tournament parameters, data reporting (for accounting purposes), data management, scheduling, calculation of rankings and winners, and display interfacing.

A configuration and reporting graphical unit interface (GUI) 12 allows an operator to remotely configure the tournament server 10. The configuration settings are then stored in memory. The GUI 12 may display a series of selection menus with various options. The GUI 12 interfaces with the tournament server 10 via a web-based interface. The operator logs onto the GUI 12, selects the various parameters for the tournament, defines the schedules for the tournaments, assigns certain gaming machines for participation in each tournament, defines messages to be displayed including prizes for winning the tournament, designates particular display devices for displaying information, designates an update rate for displaying rankings, and identifies data to be reported for accounting purposes. Other configurations and reporting functions may also be provided.

The parameters of the tournament include the criteria for winning the tournament. Criteria for winning may be either the most money wagered, the most maxbet wagers made, the most winning outcomes, the most credits won, the most money won, the most money lost, the highest payout/pay-in ratio, the most plays, or any other criteria.

A display controller 14 is connected to one or more large overhead displays 16, such as thin film transistor displays, light arrays, CRTs, etc., for issuing the signals used by the displays to display the desired information such as the start of the tournament, the players' rankings, the end of the tournament, and the prize won. An audio unit 17 controls speakers.

A bus 18 connects the tournament server 10 (and any other servers 20) to floor servers 22. The various devices may communicate using standard protocols, such as Ethernet. Floor servers 22 perform well known functions of interfacing between the gaming machines and servers by, for example, polling the gaming machines, receiving packets of data from the servers or gaming machines, and processing the signals for retransmission at appropriate times.

Each floor server 22 is connected via a bus 24 to a plurality of gaming machines. Each gaming machine has a communications board electrically connected to the bus 24 and to the appropriate circuit boards in the gaming machine for transmitting and receiving command and data signals to and from the bus 24. Communication boards are conventional. One example of a communications board is machine data controller (MDC) card 26. One MDC card 26 is shown in more detail. MDC card 26 includes an input/output unit 28, which is a conventional port used for communicating via an Ethernet. A CPU 30 and EEPROM 32 are also connected in the MDC card 26. The EEPROM 32 stores information about the associated gaming machine. The CPU 30 controls the data communications between I/O unit 28, EEPROM 32, and the network. The various means of packetizing data, unpacketizing data, parsing data, and communicating serial data via the Ethernet is well known and need not be described herein.

MDC card 26 communicates with processors and memory in the gaming machine and with the network using appropriate protocols. MDC card 26 may perform all or some of the following tasks:

Communicates with the floor server;

Interfaces to the different types of gaming machines;

Controls any player interface module (i.e., card reader, speaker, keypad, display);

Sends out exception messages for each event happening on the gaming machine or player interface module;

Communicates with additional devices like door switches and in-machine displays;

Stores all gaming machine meter amounts (including the current credit meter amount) in a memory;

Stores exception messages until acknowledged by the floor server; and

Runs accounting, player tracking, and cashless applications.

MDC 26 may be operated by firmware that can be downloaded through the floor network.

FIG. 2 illustrates a single gaming machine 33 representing any of the plurality of gaming machines connected to the network. An MDC card 26 (or any conventional communications card) is located in each machine 33. There may be a variety of types of MDC/communication cards used in the various machines playing in a tournament.

Machine 33 is shown as a video-type gaming machine; however, the invention may be used with gaming machines having motor-driven reels or displaying any other type of game. A video screen 34 displays virtual rotating reels having symbols thereon or any other type of game. In one of the most popular games, an array of randomly selected symbols appears on screen 34, and awards are granted to the player for various symbol combinations across one or more pay lines. The term random is intended to mean random and pseudo-random. Machine 33 may also play a video game of cards, such as poker or blackjack. Player-controlled buttons 35 allow the player to command machine 33 to, for example, place a bet, place a maxbet, start the reels, cash out, draw cards, deal cards, or convey any other command suitable to the particular game being played. The machine 33 may have controllable lights 36 and speakers 37. Money or ticket slots 38 and a coin tray 39 are also shown. All data generated by the machine 33 is downloadable on the network.

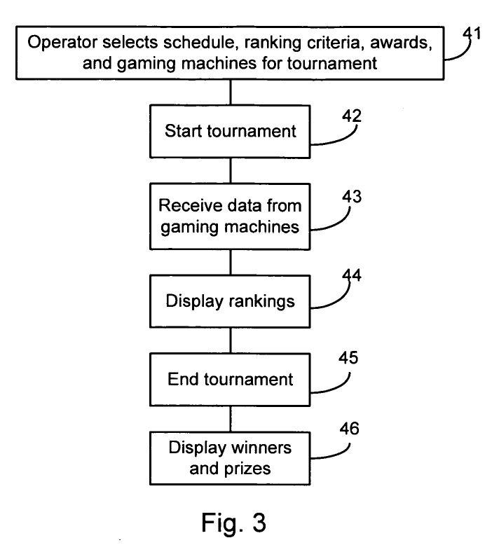

FIG. 3 is a high level flowchart of one method performed by the system of FIG. 1. In step 41, a casino operator, using the GUI 12, selects the tournament schedule (start times and end times), the criteria for winning, the gaming machines, the prizes, the displays, and any other suitable data.

In step 42, the tournament starts. The players are informed of the tournament by overhead displays, an audio presentation, and/or by the controlling of the gaming machines' lights and speakers. The players continue to play the gaming machines in the usual manner except now there is additional excitement because they are involved in a competitive tournament. During the tournament, the players may increase their bets in order to increase their chances of winning the tournament prize. The player may deposit additional funds into the machine if the player needs more credits for playing. During a tournament, the casino will typically receive increase revenue from the machines, offsetting the casino's cost of the prize.

In step 43, the pay-in/payout data and other pertinent data for each machine are downloaded to the tournament server 10 via the network.

In step 44, the tournament server 10 calculates the player rankings based on the criteria set by the operator. The ranking update frequency is set by the operator.

In step 45, the tournament ends (e.g., after 10 minutes), and the players are notified of the ending with a video (animation) and audio presentation by an overhead display unit.

In step 46, the final rankings are determined and displayed along with the prize won. If player tracking cards are used, the winning player's name may be displayed. The winning player's machine may be controlled by the tournament server 10 to carry out a particular light and sound display.

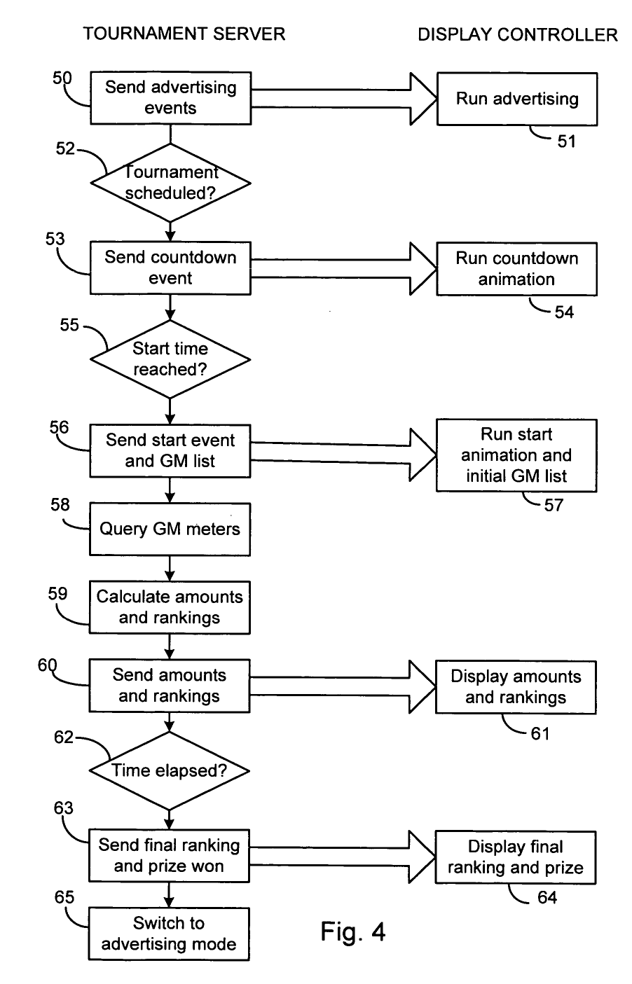

FIG. 4 is a more detailed flowchart of the functions carried out by the tournament server 10 and display controller 14.

In steps 50 and 51 of FIG. 4, while no tournament is occurring, the tournament server 10 commands the display controller 14 to run advertising on the overhead display 16. The advertising may relate to the scheduling of the tournament or any other information.

In step 52, it is determined whether the tournament is scheduled to begin.

If the tournament is scheduled to begin shortly, then in steps 53 and 54 a countdown is begun, and countdown animation is run on the overhead display so that the players' level of excitement builds and new players may participate in the tournament. The gaming machines that are to take part in the tournament may be identified by the overhead display, and/or the lights on the selected machines may be controlled to indicate that they are involved in the tournament.

In step 55, it is determined if the start time has been reached.

If the start time is reached, then in steps 56 and 57, the tournament server 10 initiates the tournament start. Starting animation is displayed, and the involved gaming machines may be identified. The players then play the gaming machine in a conventional manner. The players wager their own credits and keep their winnings. The odds of winning and the pay tables do not change.

In step 58, the tournament server 10 sends command signals to the floor servers 22 to transmit the meter information from each gaming machine to the tournament server 10. The meter information is all information needed by the tournament server 10 to calculate the rankings. The meter information may include the pay-in, the payout, the number of maxbets, the number of wins, the number of plays, etc.

In steps 59, 60, and 61, the tournament server 10 calculates the rankings based on the meter amounts. The current rankings and relevant amounts are transmitted to the display controller 14 for display.

In step 62, it is determined if the tournament time has elapsed. A countdown animation may be displayed.

If the time has elapsed, then in steps 63 and 64 the final rankings are determined and transmitted to the display controller 14 for display to all the players. The prize won may also be displayed. The player then collects the prize. The prize may be a monetary or non-monetary award. Since, in one embodiment, a percentage of the wagers is not used to fund the tournament prize, the casino funds the prize out of a marketing pool or any other pool not funded by a percentage of the wagers. Since the prize is independent of the operation of the gaming machines, the tournament can be run without impacting the gaming machine operation and without any software modifications to the gaming machines, including the paytable. By the players playing longer and more players playing as a result of the tournament feature, the cost of the prize is offset by additional revenue from the machines.

In step 65, the tournament server 10 reverts back to its advertising mode.

The functions performed during a tournament may be performed using conventional hardware and may differ from the embodiments described herein. A variety of different gaming machines from different manufacturers may be involved in the same tournament. Even machines with different credit amounts (e.g., dollar machines and nickel machines) may participate in the same tournament.

Having described the invention in detail, those skilled in the art would appreciate that given the present disclosure, modifications may be made to the invention without departing from the spirit of the inventive concepts described herein. Therefore, it is not intended that the scope of the invention be limited to the specific embodiments illustrated and described.

What is claimed is:

1. A gaming system comprising:
a plurality of gaming machines connected in a network, a normal mode of the gaming machines generating winning and losing outcomes based, at least in part, on random events, the normal mode occurring in the absence of a tournament; and
a tournament server communicating with the network, the tournament server for establishing criteria for winning a tournament by one or more players playing the gaming machines, and for detecting data from the gaming machines during a tournament to determine one or more winning players,
the tournament server detecting data from the gaming machines while players are playing the gaming machines in the gaming machines' normal mode without requiring reconfiguration of the gaming machines for playing in the tournament.

2. The system of claim 1 wherein the tournament server determines a prize won by the one or more winning players.

3. The system of claim 2 wherein the prize is not funded by any portion of wagers made on the plurality of gaming machines.

4. The system of claim 1 further comprising a user interface, the tournament server receiving configuration signals from the interface identifying tournament schedules and criteria for winning a tournament.

5. The system of claim 1 wherein the criteria for winning is based on the most winning outcomes during a tournament, the most credits won during a tournament, the most money wagered during a tournament, the most money won during a tournament, or the most maximum bet wagers made during a tournament.

6. The system of claim 1 wherein the plurality of gaming machines comprises a variety of types of gaming machines.

7. The system of claim 6 wherein the variety of types of gaming machines comprises gaming machines made by different manufacturers.

8. The system of claim 6 wherein the variety of types of gaming machines comprises gaming machines having different credit denominations.

9. The system of claim 1 wherein detecting data from the gaming machines during a tournament comprises detecting payment data.

10. The system of claim 1 wherein detecting data from the gaming machines during a tournament comprises detecting pay-in and payout data.

11. The system of claim 1 wherein detecting data from the gaming machines during a tournament comprises detecting win data.

12. The system of claim 1 further comprising a common display for a plurality of players, the tournament server controlling information displayed on the common display.

13. The system of claim 12 wherein the tournament server calculates a ranking of players during a tournament and causes the ranking to be displayed on the common display.

14. The system of claim 1 wherein odds of obtaining winning outcomes on any gaming machine are not affected when a tournament is initiated, any credits won by players during a tournament being treated the same as credits won during normal play not during a tournament.

15. The system of claim 1 wherein the system is wholly located in a casino.

16. The system of claim 1 further comprising one or more floor servers connected between the plurality of gaming machines and the tournament server.

17. The system of claim 1 wherein the tournament server selects a first plurality of gaming machines for participating in a tournament, the first plurality being selected from a larger second plurality of gaming machines that may communicate with the tournament server.

18. The system of claim 17 wherein the tournament server varies which gaming machines participate in a tournament.

19. A gaming method comprising:
operating a plurality of gaming machines connected in a network, a normal mode of the gaming machines generating winning and losing outcomes based, at least in part, on random events, the normal mode occurring in the absence of a tournament;
selecting a certain plurality of gaming machines by a tournament server to participate in a tournament;
initiating a tournament by the tournament server, wherein the certain plurality of gaming machines participate in the tournament, the tournament server establishing criteria for winning a tournament by one or more players playing the gaming machines; and
communicating by the tournament server with the network for detecting data from the gaming machines during a tournament to determine one or more winning players based on the criteria for winning, the tournament server detecting the data from the gaming machines while players are playing the gaming machines in the gaming machines' normal mode without requiring reconfiguration of the gaming machines for playing in the tournament.

20. The method of claim 19 further comprising determining a prize won by the one or more winning players, wherein the prize is not funded by any portion of wagers made on the plurality of gaming machines.

21. The method of claim 19 wherein the criteria for winning is based on the most winning outcomes during a tournament, the most credits won during a tournament, the most money wagered during a tournament, the most money won during a tournament, or the most maximum bet wagers made during a tournament.

22. The method of claim 19 wherein the plurality of gaming machines comprises a variety of types of gaming machines.

23. The method of claim 19 further comprising:
calculating by the tournament server a ranking of players during a tournament; and
controlling a common display for a plurality of players to display the ranking.

24. The method of claim 19 wherein selecting a certain plurality of gaming machines by the tournament server comprises the tournament server selecting a first plurality of gaming machines for participating in a tournament, the first plurality being selected from a larger second plurality of gaming machines that may communicate with the tournament server, wherein the tournament server varies which gaming machines participate in a tournament.
